(19) United States
(12) Patent Application Publication
(10) Pub. No.: US 2010/0217513 A1
(43) Pub. Date: Aug. 26, 2010

(54) Navigation Apparatus and Route Search Method

(75) Inventor: Atsushi Takeda, Iwaki-city (JP)

Correspondence Address: ALPINE/BHGL, P.O. Box 10395, Chicago, IL, 60610, US

(73) Assignee: Alpine Electronics, Inc., Tokyo (JP)

(21) Appl. No.: 12/695,573

(22) Filed: Jan. 28, 2010

(30) Foreign Application Priority Data
Feb. 26, 2009 (JP) 2009-043342

(51) Int. Cl. G01C 21/36

(52) U.S. Cl. 701/200

(57) ABSTRACT

A navigation apparatus and route search method by which a roundabout route is avoided even if there is a segment with a regulation such as “no left turn” or “no entrance” are disclosed.

The route search method for a navigation apparatus by which a route to a destination defined by a predetermined segment having its endpoint at an intersection is searched in the case where a destination or a stopover point is the intersection. In the case where the destination or the stopover point is an intersection CP, route search is performed in accordance with each segment SEG₁ to SEG₄ having their endpoint at the intersection CP searched as a destination segment. An optimal route (for example, the shortest route) is selected from among the searched routes, and the optimal route is determined to be a guide route to the destination or the stopover point.

### RELATED APPLICATIONS

The present application claims priority to Japanese Patent Application Number 2009-043342, filed Feb. 26, 2009, the entirety of which is hereby incorporated by reference.

### BACKGROUND OF THE INVENTION

The present invention relates to a navigation apparatus and a route search method, and more specifically to a navigation apparatus and a route search method for searching for a route to a destination segment in the case where a destination or a stopover point is an intersection by setting the intersection as an endpoint of the destination segment.

An on-vehicle navigation apparatus not only displays a map, but also searches for a route to a destination at the time of guiding and displays the searched route (guide route) on the map, thereby guiding a vehicle to the destination. When the vehicle approaches an intersection on the guide route, the on-vehicle navigation apparatus displays an enlarged illustration of the intersection indicating a distance to the intersection and a travelling direction of the vehicle at the intersection using an arrow and a voice if it is needed.

The navigation apparatus includes a map database that stores map data therein, performs a route search process and a map matching process based on road information stored in the map database, and displays a map based on background map information and text information. There are two different formats used to store the road information in the map database. One format is a database based on road segments (road segment based database) as employed in the United States and Europe, in which intersections are not described. The other format is a database based on intersections (nodes) (node based database), in which the significance of the information stored in the database is attached to the nodes (intersections), and a road is defined as a connection between nodes.

FIG. 10 is a schematic diagram of a part of the road segment based database. The first column lists road names in the database in the alphabetical order, e.g., all of the road names in California, where Road₂, which is one of the roads in California, is defined by data listed in the second column that includes road data. The first cell of the road data column of Road₂ includes a road name or a road identification name (“Road₂”), and the remaining cells include road segments that form the road, which generally includes a number of segments extending from an intersection to a next intersection. A road segment₁ in the road data column is defined by data shown in the third column. The road segment₁ extends from a node point NDPT₁₁ to a node point NDPT₁₂. The next data in the road segment data indicates in which direction the vehicle is allowed to travel along the road segment, and the last data indicates the road segment length expressed in miles. It should be noted that “Only right” indicates a one-way traffic in a direction from NDPT₁₁ to NDPT₁₂, “Only left” indicates a one-way traffic in an opposite direction, and “right and left” indicates a two-way traffic.

In the road segment based database, a road is defined by a series of linked road segments and not by a series of intersections linked by road segments. The road segment based database is different from the intersection (node) based database in this point.

There is a case where the destination is specified by a node, e.g. an intersection, in the navigation apparatus that includes such a road segment based database. FIG. 11(A) shows a case where two streets (roads) RD₁ and RD₂ are selected and an intersection of them is selected as a destination.

However, the navigation apparatus using the road segment based database requires the destination specified to be an endpoint of a predetermined road segment, because the road information is generated and stored in the road segment format as described above. Therefore, conventionally, as shown in FIG. 11(B), a predetermined segment S₃ among a plurality of segments S₁ to S₄ having an endpoint at the intersection CP is set as a destination segment (a flag FG is set there), and a route to the destination segment is searched for. In the case shown in FIG. 11(B), the navigation apparatus recognizes that the travel distance within the destination segment S₃ is zero.

There may be a case where the vehicle cannot enter the intersection set as the destination because a left turn or an entrance is prohibited when travelling in a predetermined direction. In such a case, if the navigation apparatus selects the segment regulated by prohibiting the left turn or the entrance as the destination segment, a roundabout route may be disadvantageously selected. For example, when the left turn is prohibited at the intersection CP of the roads RD₁ and RD₂ as shown in FIG. 12(A), if the intersection is input as the destination and the segment S₃ is set as the destination segment, because the vehicle cannot turn left at the intersection CP in the direction of the segment S₃, a route indicated by a thick line in the figure is selected, which is a roundabout route.

Described above is a case of selecting the two roads RD₁ and RD₂ and selecting the intersection of them CP as the destination. However, the same problem occurs when the two roads RD₁ and RD₂ are selected and the intersection of them CP is selected as a stopover point, as shown in FIG. 12(B).

Conventionally, there is proposed a guide route search method for a navigation apparatus including a road segment based database (See Japanese Patent Application Publication 1998 H 10-89987). According to this patent document, when an intersection is specified as the destination, a route search is performed by removing a segment of one-way traffic where it is prohibited to travel in a direction to get out of the intersection among many segments having their endpoint at the intersection, and by setting any one of the remaining segments as the destination segment. A long route is avoided because such a one-way segment is not set as the destination segment. However, this patent document does not solve the problem of searching roundabout routes if there is a segment at the intersection selected as the destination or the stopover point where there is a regulation on travelling such as “no left turn” or “no entrance”.

### BRIEF DESCRIPTION OF THE INVENTION

From the above point of view, in the present application, a technique for avoiding a roundabout route even if there is a segment at an intersection selected as a destination or a stopover point where there is a regulation on travelling such as “no left turn” or “no entrance” is disclosed.

Further, a technique for searching for a route so that a travel distance within a destination segment is not zero is disclosed.

One embodiment provides a navigation apparatus and a route search method for searching for a route to a destination segment in the case where a destination or a stopover point is an intersection by setting a predetermined segment having an endpoint at the intersection as the destination segment.

### A Route Search Method

A route search method according to one embodiment includes the steps of, searching routes to a destination segment by setting each segment having its endpoint at an intersection as the destination segment in the case where a destination or a stopover point is an intersection, selecting an optimal route from among the routes searched during the searching, and determining the optimal route to be a guide route to the destination or the stopover point. It should be noted that the optimal route means a route of which a travel distance within the destination segment is not zero.

### Navigation Apparatus

A navigation apparatus according to another embodiment includes a destination setting unit configured to set a destination or a stopover point at an intersection, a route search unit configured to search routes to a destination segment by setting each segment having an endpoint thereof at the intersection as the destination segment and select an optimal route from among searched routes, a guide route memory configured to store therein the optimal route as a guide route to the destination or the stopover point, and a route guide unit configured to control route guidance along the guide route.

The route search unit selects, as the optimal route, the shortest route or the shortest route in which a travel distance within the destination segment is not zero. The destination setting unit sets the destination or the stopover point as the intersection of two roads.

According to another embodiment, even if there is a segment with a regulation such as “no left turn” or “no entrance”, the segment is not set as a destination segment and a roundabout route is avoided. This is because, in the case where a destination or a stopover point is an intersection, route search is performed by setting each segment having its endpoint at the intersection as a destination segment, so that an optimal route is selected from among the searched routes and the optimal route is determined to be a guide route to the destination or the stopover point.

Further, according to another embodiment, a segment within which a travel distance is zero is removed from a segment list for selecting a guide route, and improper intersection guidance toward the segment within which the travel distance is zero is surely avoided. This is because the shortest route where the travel distance within the destination segment is not zero is selected as an optimal route.

### BRIEF DESCRIPTION OF THE DRAWINGS

FIGS. 1(A) to 1(D) are schematic diagrams for explaining an exemplary embodiment in a case of setting a destination as an intersection of two roads and searching for a route to the destination;

FIGS. 2(A) to 2(D) are schematic diagrams for explaining a case of setting a stopover point as an intersection of two roads and searching for a route to the stopover point;

FIG. 3 is a block diagram of a navigation system according to an exemplary embodiment;

FIG. 4 shows an example of a segment list of a guide route;

FIG. 5 is a schematic diagram for explaining a destination segment;

FIG. 6 is another schematic diagram for explaining the destination segment;

FIG. 7 shows an example of a description of the segment list in the case shown in FIG. 6;

FIG. 8 is a flowchart of a route search process according to an exemplary embodiment;

FIG. 9 is a flowchart of a route search process according to another exemplary embodiment;

FIG. 10 is a schematic diagram of a part of the road segment based database;

FIGS. 11(A) and 11(B) are schematic diagrams for explaining a destination input method of entering or selecting two streets (roads) and entering or selecting an intersection of them as a destination; and

FIGS. 12(A) and 12(B) are schematic diagrams for explaining a problem with the conventional route search method.

### DETAILED DESCRIPTION OF THE INVENTION

### (A) Examples

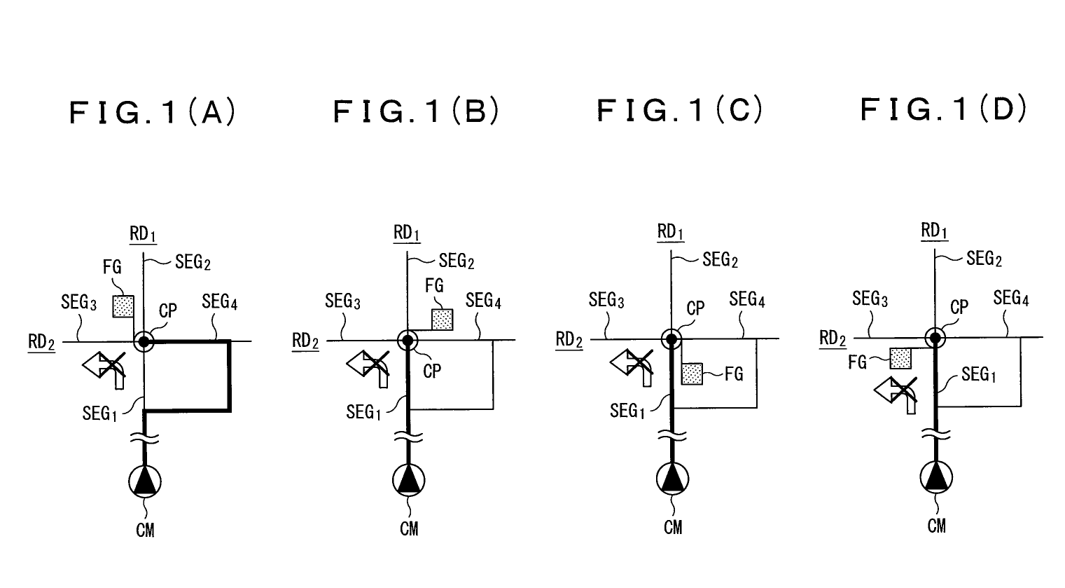

FIGS. 1(A) to 1(D) are schematic diagrams for explaining an exemplary embodiment in a case where a left turn is prohibited. CM in FIGS. 1(A) to 1(D) is a vehicle mark indicative of a vehicle location.

When a destination is set at an intersection CP of two roads RD₁ and RD₂, routes are searched by setting each of a plurality of segments SEG₁ to Seg₄ having their endpoint at the intersection CP as a destination segment. An optimal route (for example, the shortest route) is selected from among the searched routes, and the optimal route is determined to be a guide route to the destination.

FIG. 1(A) shows a case of setting the segment SEG₃ as the destination segment. In this case, because it is prohibited to turn left, a route “start segment- . . . -SEG₁-SEG₃” that includes a left turn cannot be selected as the guide route, and the searched route is indicated by a thick line near the destination, which is a roundabout route to the destination segment.

FIG. 1(B) shows a case of setting the segment SEG₂ as the destination segment. In this case, because there is no traffic regulation on the segment SEG₂, a route “start segment - . . . - SEG₁-SEG₂ (travel distance is zero)” can be selected as the guide route, and the searched route is indicated by a thick line near the destination, which is the shortest route to the destination. However, the travel distance within the destination segment SEG₂ is zero, and therefore an extra segment SEG₂ within which the travel distance is zero is included in the searched route.

FIG. 1(C) shows a case of setting the segment SEG₄ as the destination segment. In this case, because there is no traffic regulation on the segment SEG₄, a route “start segment - . . . -SEG₁-SEG₄ (travel distance is zero)” can be selected as the guide route, and the searched route is indicated by a thick line near the destination, which is the shortest route to the destination. However, the travel distance within the destination segment SEG₄ is zero, and therefore an extra segment SEG₄ within which the travel distance is zero is included in the searched route.

FIG. 1(D) shows a case of setting the segment SEG, as the destination segment. In this case, a route “start segment - . . . - SEG₁” can be selected as the guide route, and the searched route is indicated by a thick line near the destination, which is the shortest route to the destination. Furthermore, the travel distance within the destination segment is not zero but equal to the length of the segment. In other words, an extra segment within which the travel distance is zero is not included in the searched route.

Based on the above-described results, if the optimal route means the shortest route, any one of the routes shown in FIGS. 1(B) to 1(D) can be determined to be the guide route.

If the optimal route means the shortest route in which the travel distance within the destination segment is not zero, the route shown in FIG. 1(D) should be determined to be the guide route.

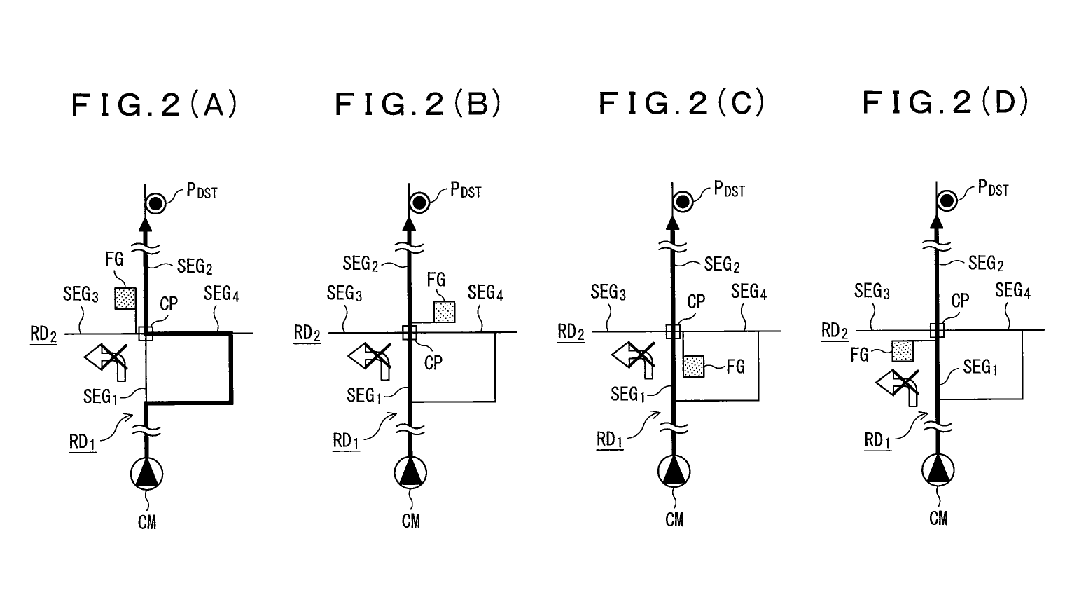

FIGS. 2(A) to 2(D) are schematic diagrams for explaining a case of setting a stopover point as the intersection CP of the two roads RD₁ and RD₂ and searching for a route to the stopover point. The same reference numerals are used for the same elements as shown in FIGS. 1(A) to 1(D), and P_{DST} indicates the destination.

Routes are searched by setting each of the plurality of segments Seg₁ to SEG₄ having their endpoint at the intersection CP of the two roads RD₁ and RD₂, which is the stopover point, as a stopover segment. The optimal route (for example, the shortest route) is selected from among the searched routes, and the optimal route is determined to be the guide route to the stopover point. The optimal route is a minimum-cost route, which is, for example, a route with the shortest distance if the distance is prioritized, a route taking the shortest time if time is prioritized, a route with the minimum cost preferentially using highways if use of the highways is prioritized, and a route with the minimum cost preferentially using open roads if use of the open roads is prioritized.

FIG. 2(A) shows a case of setting the segment SEG₃ as the stopover segment. In this case, because it is prohibited to turn left, a route “start segment- . . . -SEG₁-SEG₃” that includes a left turn cannot be selected as the guide route, and the searched route is indicated by a thick line near the stopover point, which is a roundabout route to the destination segment.

FIG. 2(B) shows a case of setting the segment SEG₂ as the stopover segment. In this case, because there is no traffic regulation on the segment SEG₂, a route “start segment - . . . - SEG₁-SEG₂ (travel distance is zero)” can be selected as the guide route, and the searched route is indicated by a thick line near the stopover point, which is the shortest route to the stopover point. However, the travel distance at the stopover segment SEG₂ is zero, and therefore an extra segment SEG₂ within which the travel distance is zero is included in the searched route, and consequently the searched route to the destination point P_{DST} is:

start segment- . . . -SEG₁-SEG₂ (travel distance is zero)-SEG₂- . . . -destination segment.

FIG. 2(C) shows a case of setting the segment Seg₄ as the stopover segment. In this case, because there is no traffic regulation on the segment SEG₄, a route “start segment- . . . -SEG₁-SEG₄ (travel distance is zero)” can be selected as the guide route, and the searched route is indicated by a thick line near the stopover point, which is the shortest route to the stopover point. However, the travel distance within the stopover segment SEG₄ is zero, and therefore an extra segment SEG₄ within which the travel distance is zero is included in the searched route, and consequently the searched route to the destination point P_{DST} is:

start segment- . . . -SEG₁-SEG₄ (travel distance is zero)-SEG₂- . . . -destination segment.

FIG. 2(D) shows a case of setting the segment SEG₁ as the stopover segment. In this case, a route “start segment- . . . -SEG₁” can be selected as the guide route, and the searched route is indicated by a thick line near the stopover point, which is the shortest route to the destination. Furthermore, the travel distance within the stopover segment is not zero but equal to the length of the segment. In other words, an extra segment within which the travel distance is zero is not included in the searched route. Therefore, consequently, the searched route to the destination point P_{DST} is:

start segment- . . . -SEG₁-SEG₂- . . . -destination segment.

Based on the above-described results, if the optimal route is the shortest route, any one of the routes shown in FIGS. 2(B) to 2(D) can be determined to be the guide route to the stopover point.

If the optimal route means the shortest route that does not include any segment in which the travel distance is not zero, the route shown in FIG. 2(D) should be determined to be the guide route.

(B) Navigation System

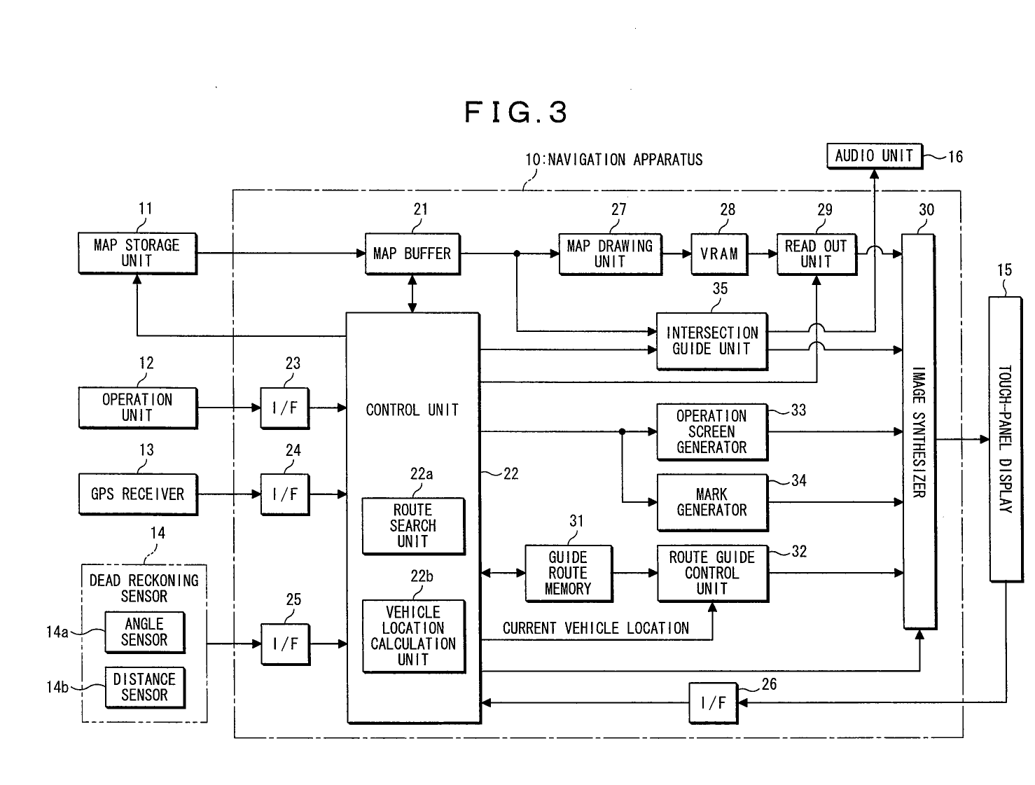

FIG. 3 is a block diagram of a navigation system according to an exemplary embodiment.

A map storage unit 11 (CD-ROM, DVD, hard disk, or the like) stores therein map data, which can be read out if it is needed. The map data includes road information used for a guide route search and a map matching, background information to display an object on a map, and text information to display a text indicative of a name of a municipality or the like on the map, and the road information has a database structure based on the road segments (road segment based database).

An operation unit 12 is used to operate a navigation apparatus 10, and includes a remote control and a keypad for an operation. A global positioning system (GPS) receiver 13 receives location information transmitted from a GPS satellite and measures a current absolute location of the vehicle. A dead reckoning sensor 14 includes an angle sensor 14a such as a gyro sensor that detects a rotation angle of the vehicle and a distance sensor 14b that generates a pulse at an interval of a predetermined travel distance, and it is configured to autonomously estimate the current location of the vehicle. The navigation apparatus 10 performs the map matching as needed to estimate the current location of the vehicle using both the GPS and the dead reckoning sensor.

A touch-panel display 15 displays a map of an area in which the vehicle is located, an enlarged illustration of an intersection, other guide information, and menu on it. The touch-panel display 15 is also configured to input a predetermined command to the navigation apparatus 10 when a soft key displayed on the screen is pressed. An audio unit 16 produces a guide voice for guiding at an intersection when the vehicle approaches the intersection.

In the navigation apparatus 10, a map buffer 21 stores therein the map data read from a map recording medium. A control unit 22 controls (1) calculation of the current vehicle location, (2) map read out for reading the map data of the area in which the vehicle is located and storing it in the buffer, (3) route search to the destination, (4) route guidance for guiding the vehicle along the searched route, (5) map matching, and (6) intersection guidance, based on various information and commands input through interfaces 23 to 26. The control unit 22 includes a route search unit 22a and a vehicle location calculation unit 22b.

A map drawing unit 27 generates a map image using the map data of the area, in which the vehicle is located, read by the map buffer 21, and writes the map image to a video random access memory (VRAM) 28. An image read out unit 29 cuts off a predetermined part of the image in the VRAM 28 based on an instruction from the control unit 22, and sends it to an image synthesizer 30.

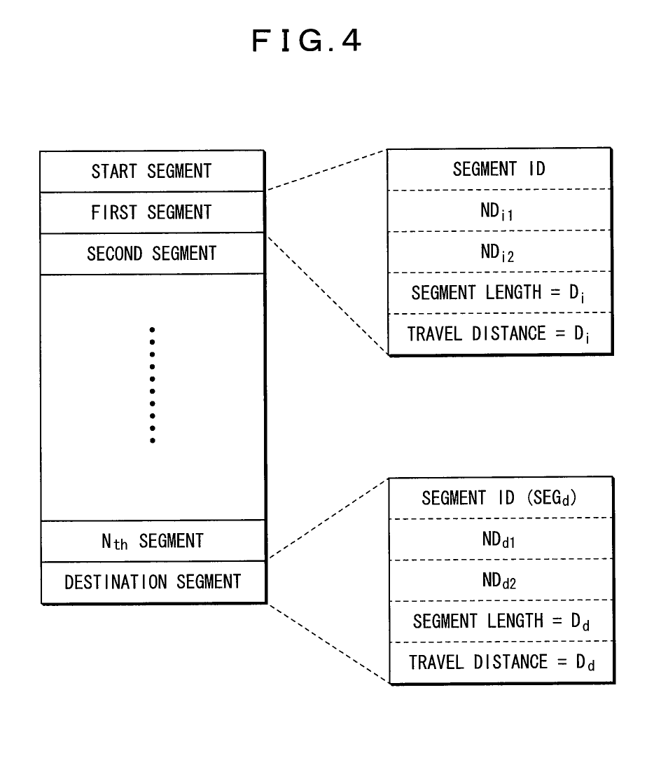

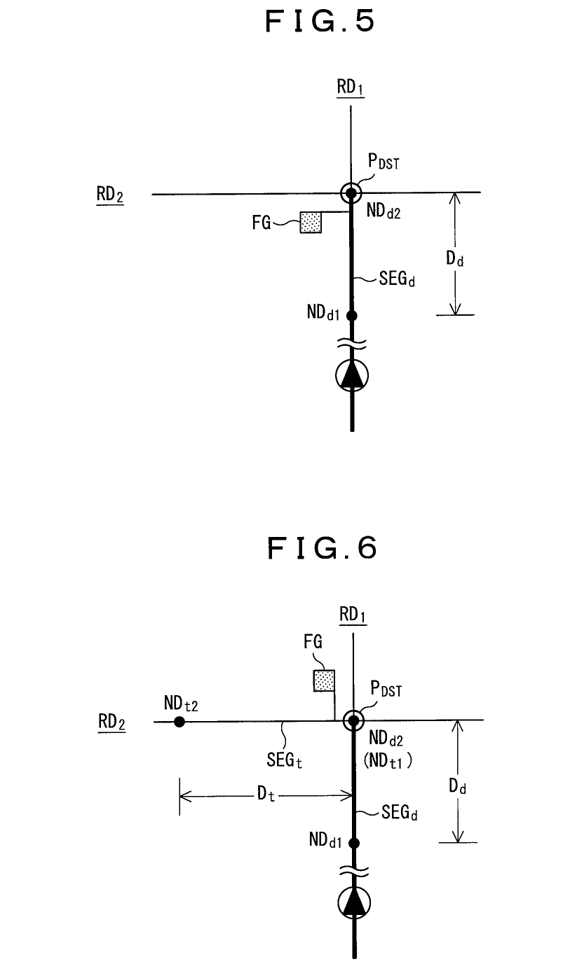

A guide route memory 31 records guide route information to the destination searched by the route search unit 22a, i.e., a list of all segments that form the guide route (segment list) in the route order from the start segment to the destination segment. FIG. 4 shows an example of the segment list of the guide route, which includes; (1) segment ID, (2) two endpoints NDi₁ and NDi₂, (3) segment length, and (4) actual travel distance, of all segments that form the guide route. FIGS. 5 to 7 are schematic diagrams for describing the destination segment.

As shown in FIG. 5, when the destination P_{DST} is set as the intersection of the two roads RD₁ and RD₂, the destination segment is set as SEG_{d} (a flag FG is set), its endpoints are set as NDd₁ and NDd₂, and its length is set as D_{d}; the travel distance should be equal to the segment length D_{d} in the description of the destination segment shown in the segment list (see FIG. 4).

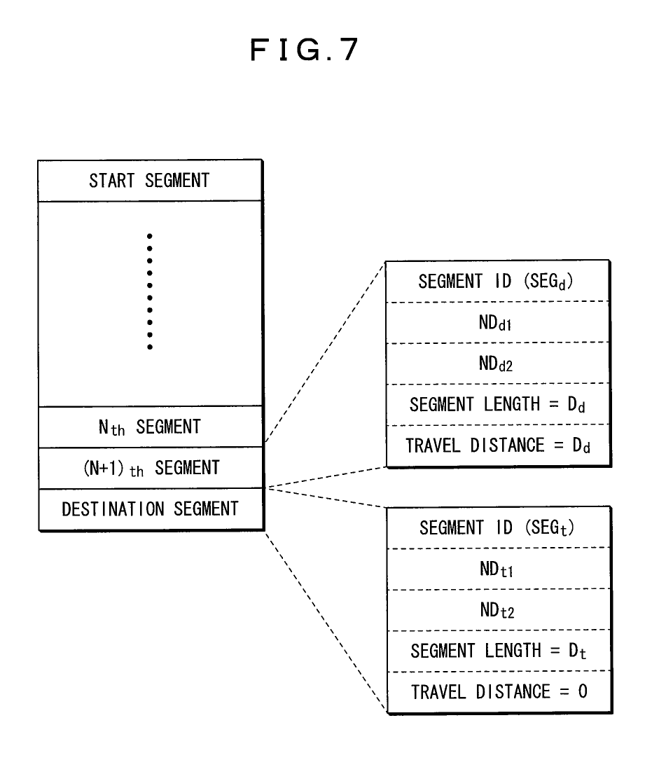

However, if the destination segment is set at SEGₜ as shown in FIG. 6, the last two segments in the segment list are described as shown in FIG. 7, where the travel distance is zero in the destination segment SEGₜ.

Returning to FIG. 3, a route guide control unit 3₂ generates a guide route image around the current vehicle location, inputs it to the image synthesizer 30, and highlights it on a drawn map, using the guide route information (segment list of the guide route) stored in the guide route memory 31. An operation screen generator 33 generates various menu screens (operation screens), and sends them to the image synthesizer 30. A mark generator 34 generates various marks such as a vehicle location mark and a cursor, and sends them to the image synthesizer 30. An intersection guide unit 35 provides route guidance at an approaching intersection through a display image and a voice. In other words, when the vehicle travels close to an intersection within a predetermined distance during actual route guidance, the intersection guide unit 35 displays an intersection guidance image (e.g. an enlarged illustration of the intersection and an arrow indicative of a travelling direction) on a display, and guides the travelling direction through the voice at the same time. The image synthesizer 30 superimposes the various marks, the image of the guide route, and the enlarged illustration of the intersection on the map image read from the VRAM 28, and displays them on the display.

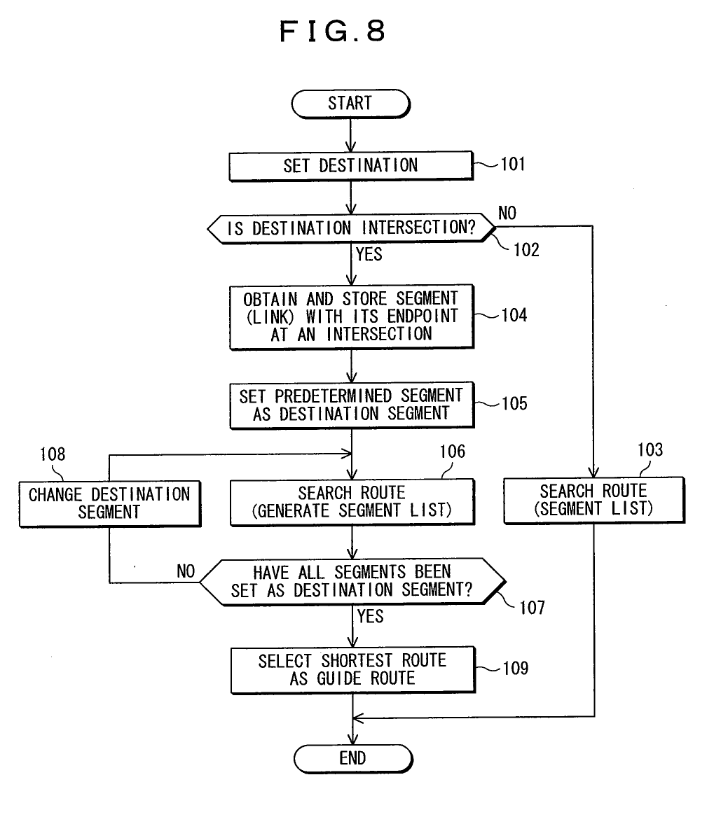

FIG. 8 is a flowchart of a route search process performed by the route search unit 22a according to an exemplary embodiment.

First, the destination is set by a predetermined method (Step 101). The method of setting the destination can be (1) specifying a municipality and an address of the destination, (2) entering or selecting an intersection as the destination by entering names of two crossing roads, (3) entering or selecting the destination based on a name, a category or a phone number of an establishment, (4) selecting the destination from a history of recently used destinations, and (5) selecting the destination from a list of registered addresses.

When the destination is entered, the route search unit 22a determines whether the destination is located at an intersection of two roads (Step 102). If the destination is not located at the intersection, the route search unit 22a performs the general route search process to generate the segment list (see FIG. 4) (Step 103), and terminates the route search process.

If the destination is located at the intersection at Step 102, all the segments (links) having their endpoint at the intersection are obtained and stored (Step 104). A predetermined one of the obtained segments is then set as the destination segment (Step 105), and a route to the destination segment is searched to generate a segment list (Step 106). It is then determined whether the route search has been performed on all the segments obtained at Step 104 (Step 107). If the route search has not been performed on all of the segments, the next segment is set as the destination segment (Step 108), and the route search at Step 106 is performed on it.

If the route search has been performed on all the segments obtained at Step 104, the shortest route is selected from among the searched routes, for example, the segment list is stored in the guide route memory 31 (Step 109), and the route search process is terminated.

Although the route search is performed from the beginning every time the destination segment is changed in the above method, routes to the destination segments can be actually searched by extending a search branch closer to the destination and changing the destination segments from that point, using a route search software (for example, Dijkstra's algorithm). In this manner, it is possible to reduce time for route searching.

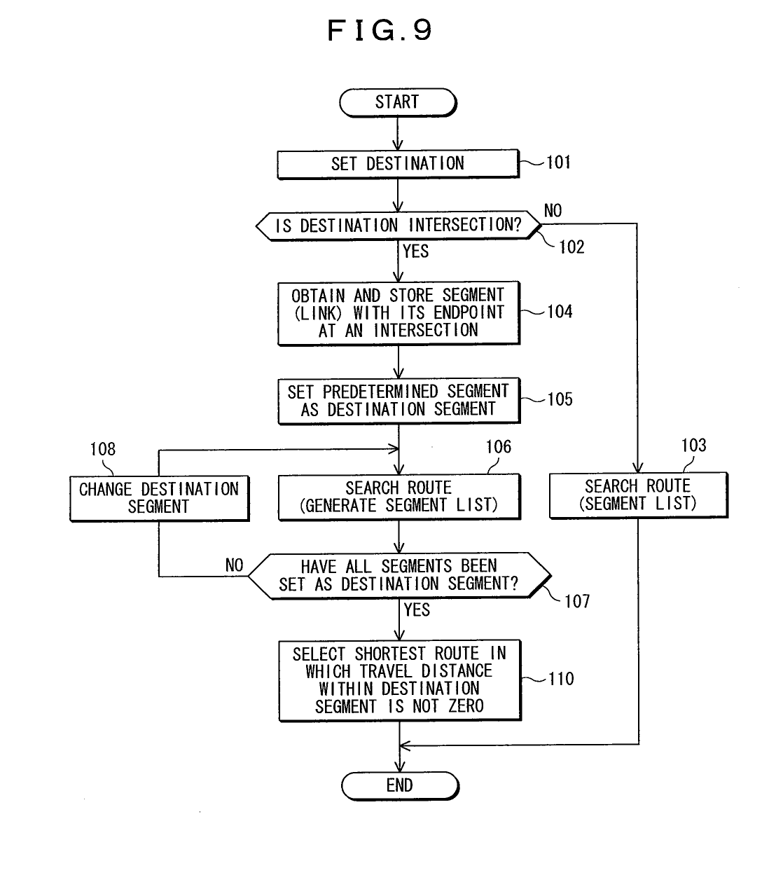

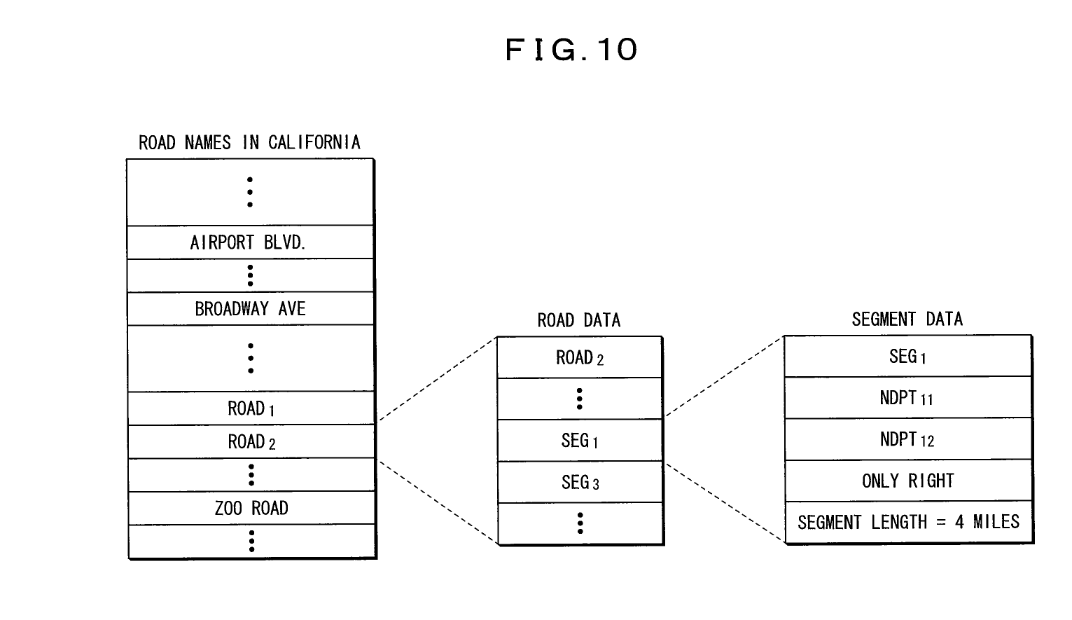

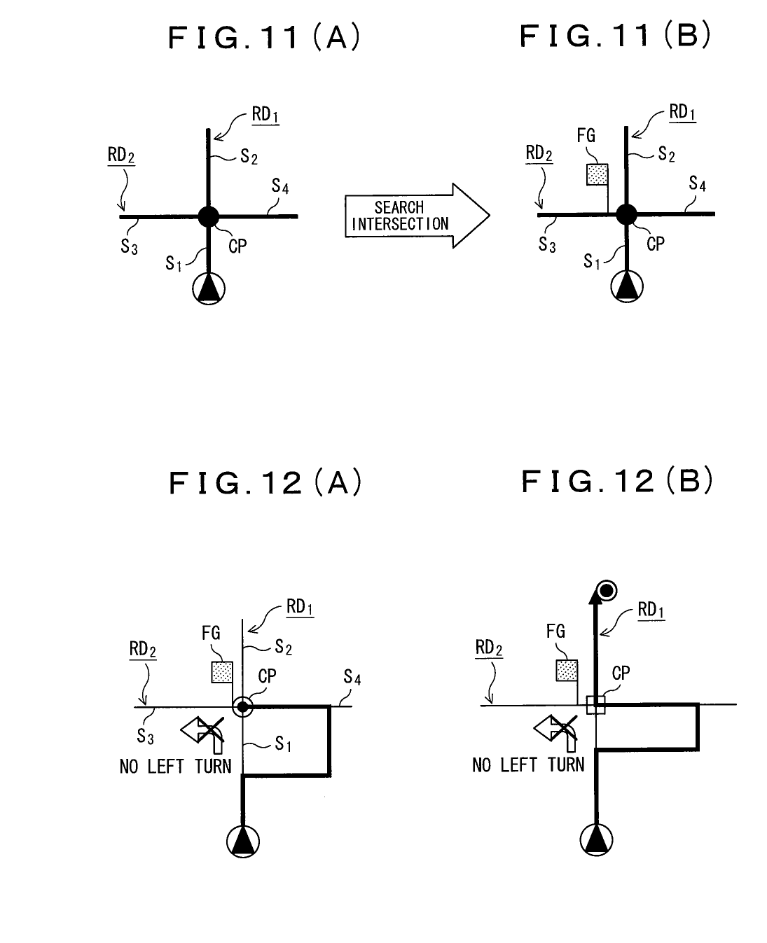

Although the optimal route is the shortest route in the flowchart shown in FIG. 8, the shortest route that does not include any segment in which the travel distance is not zero may be selected as the optimal route. FIG. 9 is a flowchart of a route search process in such a case, and the same numerals are used for the same steps as shown in FIG. 8. The only difference is Step 110 that replaces Step 109. At Step 110, the route search unit 22a selects, for example, the shortest route that does not include any segment in which the travel distance is not zero as the guide route.

Although the case of searching for a route to the destination is described above, it is possible to search for a route from the start segment to a stopover point and search for a route from the stopover point to another stopover point or the destination by performing the same process.

According to an embodiment of the present invention, even if there is a segment with a regulation such as “no left turn” or “no entrance”, the segment is not set as a destination segment and a roundabout route is avoided. This is because routes are searched by setting each segment having its endpoint at an intersection as the destination segment in the case where a destination or a stopover point is an intersection, so that an optimal route such as the shortest route is selected from among the searched routes and the optimal route is determined to be the guide route to the destination or the stopover point.

Further, according to another embodiment, a segment within which the travel distance is zero is removed from a segment list for selecting a guide route and improper intersection guidance toward the segment within which the travel distance is zero is surely avoided. This is because the shortest route where the travel distance within a destination segment is not zero is selected as an optimal route.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. A route search method for a navigation apparatus for searching for a route to a destination segment by setting a predetermined segment having an endpoint thereof at an intersection as the destination segment in the case where a destination or a stopover point is the intersection, the method comprising:
searching for routes to the destination segment by setting each segment having the endpoint thereof at the intersection as the destination segment in the case where the destination or the stopover point is the intersection;
selecting an optimal route from among the routes associated with segments having the endpoint thereof at the intersection identified during the search for routes to the destination segment; and
determining the optimal route to be a guidance route to the destination or the stopover point that is displayed by the navigation apparatus.

2. The route search method according to claim 1, wherein the destination or the stopover point is set as an intersection of two roads.

3. The route search method according to claim 1, wherein the optimal route is the shortest route.

4. The route search method according to claim 3, wherein the destination or the stopover point is set as an intersection of two roads.

5. The route search method according to claim 1, wherein the optimal route is the shortest route in which a travel distance within the destination segment is not zero.

6. The route search method according to claim 5, wherein the destination or the stopover point is set as an intersection of two roads.

7. A navigation apparatus for searching for a route to a destination segment by setting a predetermined segment having an endpoint thereof at an intersection as the destination segment in the case where the destination or a stopover point is the intersection, the navigation apparatus comprising:
a destination setting unit configured to set the destination or the stopover point at the intersection;
a route search unit configured to search for routes to the destination segment by setting each segment having the endpoint thereof at the intersection as the destination segment and select an optimal route from among the routes associated with segments having the endpoint thereof at the intersection identified during the search for routes to the destination segment;
a guide route memory configured to store therein the optimal route as a guidance route to the destination or the stopover point; and
a route guide unit configured to control route guidance presented by the navigation apparatus along the guidance route.

8. The navigation apparatus according to claim 7, wherein the destination setting unit sets the destination or the stopover point as an intersection of two roads.

9. The navigation apparatus according to claim 7, wherein the route search unit selects the shortest route as the optimal route.

10. The navigation apparatus according to claim 9, wherein the destination setting unit sets the destination or the stopover point as an intersection of two roads.

11. The navigation apparatus according to claim 7, wherein the route search unit selects the shortest route in which a travel distance within the destination segment is not zero as the optimal route.

12. The navigation apparatus according to claim 11, wherein the destination setting unit sets the destination or the stopover point as an intersection of two roads.

13. A route search method for a navigation apparatus for searching for a route to a destination segment by setting a predetermined segment having an endpoint thereof at an intersection as the destination segment in the case where a destination or a stopover point is the intersection, the method comprising:
searching for routes to the destination segment by setting each segment having the endpoint thereof at the intersection as the destination segment in the case where the destination or the stopover point is the intersection;
selecting an optimal route from among the routes associated with segments having the endpoint thereof at the intersection identified during the search for routes to the destination segment; and
determining the optimal route to be a guidance route to the destination or the stopover point that is displayed by the navigation apparatus, the optimal route being the shortest route to the destination in which a travel distance within the destination segment is not zero.
